(19) United States
(12) Patent Application Publication
(10) Pub. No.: US 2020/0372772 A1
(43) Pub. Date: Nov. 26, 2020

(54) SYSTEM AND METHOD FOR MONITORING SECURITY OF OCCUPANTS IN RIDESHARING ENVIRONMENT

(71) Applicant: Daniel Michael D'Agostino, Laveen, AZ (US)

(72) Inventor: Daniel Michael D'Agostino, Laveen, AZ (US)

(73) Assignee: Daniel Michael D'Agostino, Laveen, AZ (US)

(21) Appl. No.: 16/417,644

(22) Filed: May 21, 2019

(51) Int. Cl. G08B 13/196; G08B 25/08

(52) U.S. Cl. CPC G08B 13/19656; G08B 13/19684; G08B 13/19658; G08B 13/19697; G08B 25/08

(57) ABSTRACT

Disclosed is a method and system for monitoring the security of occupants in a ridesharing environment. The method captures moving images of the occupants present in a vehicle and performs analysis to recognize the face of the occupants through a video trigger module. Then the method reduces a frame rate of the captured moving images through a video compression module. The method captures audio signals generated by objects present in the vehicle through an audio trigger module. The method then transmits the captured moving images and the audio signals to a server unit through a data transmission module. The method then detects suspicious activity and facilitates a remote user to initiate a telephonic call to an emergency service provider through a monitoring module. The method analyses the captured moving images of the occupant and transmits the analyzed data to the server unit for authentication of the occupants through a biometric module.

### FIELD OF INVENTION

The present invention relates to ridesharing, in particular a system and method for monitoring the security of occupants in a ridesharing environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in-and-of-themselves may also be inventions.

Typically, mobile application based ridesharing services have brought a new transportation mode to passengers, which can make reservations using mobile applications. However, there are various challenges in the mobile application based ridesharing services such as inefficiency and unreliability of the vehicle routing plans caused by the complex topology of the urban road network, unpredictable traffic conditions, safety and security of a passenger and driver.

This specification recognizes that the users of the mobile application based ridesharing services are dangerous for passengers and drivers. Additionally, it is recognized in this specification that the existing systems and methods do not facilitate status via a voice call in real-time. Also, the existing systems do not provide a software-enabled monitoring system which provides an interface between an occupant and computing device.

It is, therefore, a need for a reliable, and efficient system and method to create a safer and monitors behavior of the occupants to prevent crime.

Thus, in view of the above, there is a long-felt need in the industry to address the aforementioned deficiencies and inadequacies.

The present invention mainly solves the technical problems existing in the prior art. In response to these problems, the present invention provides a system and method for monitoring the security of occupants in a ridesharing environment.

An aspect of the present disclosure relates to a method for monitoring the security of occupants in a ridesharing environment. The method includes a step of capturing one or more moving images of the occupants present in a vehicle and performing an analysis to recognize face of the occupants through a video trigger module. Then the method includes a step of reducing a frame rate of the captured moving images through a video compression module. Further, the method includes the step of capturing a plurality of audio signals generated by one or more objects present in the vehicle through an audio trigger module. Furthermore, the method includes the step of transmitting the captured moving images and the audio signals to a server unit through a data transmission module. The data transmission module communicatively couples one or more computing devices of the occupants to the server unit. The method then includes the step of detecting one or more predefined suspicious activity by monitoring the captured video moving images in real-time and facilitates a remote user to initiate a telephonic call to an emergency service provider such as a police station or hospital through a monitoring module. Then the method includes the step of scanning a license plate of the vehicle and transmits the data inputs to the emergency service provider such as a police station or hospital through a notification module. The plurality of data inputs includes a location of the vehicle captured moving images and captured audio signals. The notification module establishes the telephonic call between the remote user and the emergency service provider as a police station or hospital. The method then includes the step of analyzing the captured moving images of the occupant and transmits the analyzed data to the server unit for authentication of the occupants through a biometric module.

The method then includes a step of activating the ride on recognizing the captured moving images of the occupants and establish a connection with an onboard diagnostics unit of the vehicle to control a plurality of parameters of the vehicle through an activation module. Further, the method includes a step of communicating a plurality of notifications to the server unit operated by the remote user through a communication module. The method includes a step of creating partnerships with a plurality of telecommunication carriers to allow internet data from the server unit to not impact an internet data plan of the computing devices of the occupants through a data management module. The method then includes the step of facilitating the occupants to capture an image of the face to be part of the ridesharing environment through a safety module, wherein the safety module executes a plurality of facial recognition instructions to verify the occupants against pre-stored information in the database.

In an aspect, the video trigger module initiates a ride on recognizing the face of the occupants and facilitates the occupants to initiate a warning signal through a panic module integrated with the computing device of the occupant.

An aspect of the present disclosure relates to a system to monitor the security of a plurality of occupants in a ridesharing environment. The system includes a processor and a memory. The memory stores machine-readable instructions are pertaining to monitoring security of the occupants. The processor coupled to the memory and operable to execute the machine-readable instructions stored in the memory. The processor includes a video trigger module, a video compression module, an audio trigger module, a data transmission module, a monitoring module, a notification module, a biometric module, an activation module, a communication module, a data management module, and a safety module.

The video trigger module captures one or more moving images of the occupants present in a vehicle and performing an analysis to recognize face of the occupants. The video compression module reduces a frame rate of the captured moving images. The audio trigger module captures a plurality of audio signals generated by one or more objects present in the vehicle. The data transmission module transmits the captured moving images and the audio signals to a server unit. The data transmission module communicatively couples one or more computing devices of the occupants to the server unit. The monitoring module detects one or more predefined suspicious activity by monitoring the captured video moving images in real-time and facilitates a remote user to initiate a telephonic call to an emergency service provider. The notification module scans a number plate of the vehicle and transmits a plurality of data inputs to the emergency service provider. The plurality of data inputs comprising a location of the vehicle captured moving images and captured audio signals. The notification module establishes the telephonic call between the remote user and the emergency service provider. The biometric module analyzes the captured moving images of the occupant and transmits the analyzed data to the server unit for authentication of the occupants. The activation module activates the ride on recognizing the captured moving images of the occupants and establish a connection with an onboard diagnostics unit of the vehicle to control a plurality of parameters of the vehicle. The communication module communicates a plurality of notifications to the server unit operated by the remote user. The data management module creates partnerships with a plurality of telecommunication carriers to allow internet data from the server unit (such as a mobile application) to not impact an internet data plan of the computing devices of the occupants. The safety module facilitates the occupants to capture an image of the face to be part of the ridesharing environment. The safety module executes facial recognition instructions to verify the occupants against pre-stored information in the database.

In an aspect, the video trigger module initiates a ride on recognizing the face of the occupants and facilitates the occupants to initiate a warning signal through a panic module integrated with the computing device of the occupant. In an aspect, the panic module is a button that enables the occupants such as passenger and driver to notify police or ambulance service providers in case of any emergency.

Accordingly, one advantage of the present invention is that it captures video and audio of the occupants and vehicle to create a safer ridesharing experience and monitors behavior of the occupants to prevent crime from occurring.

Accordingly, one advantage of the present invention is that it provides a mobile application platform with a plurality of security and safety features such as video, audio, and biometrics to provide a safer ridesharing experience.

Other features of embodiments of the present disclosure will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a network implementation of the present system and method to monitor the security of a plurality of occupants in a ridesharing environment, in accordance with an embodiment of the present invention.

FIG. 2 illustrates the present system to monitor the security of a plurality of occupants in a ridesharing environment, in accordance with an embodiment of the present invention.

FIG. 3 illustrates a flowchart of the method for monitoring security of a plurality of occupants in a ridesharing environment, in accordance with an embodiment of the present invention.

### DETAILED DESCRIPTION

Systems and methods are disclosed for monitoring security of a plurality of occupants in a ridesharing environment. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

Although the present disclosure has been described with the purpose of monitoring security of a plurality of occupants in a ridesharing environment, it should be appreciated that the same has been done merely to illustrate the invention in an exemplary manner and any other purpose or function for which explained structures or configurations could be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory or memory devices.

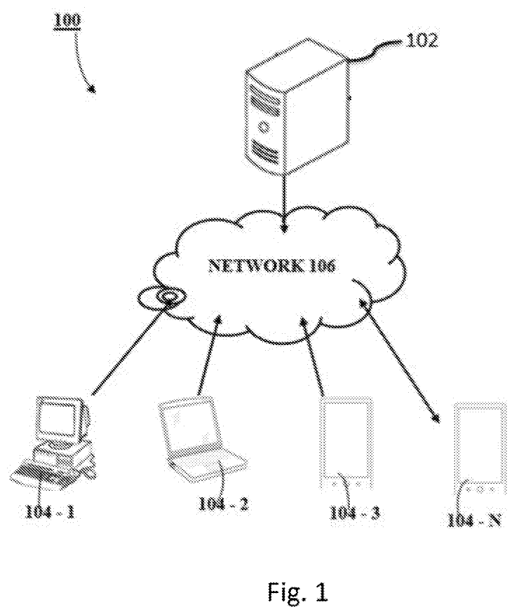

FIG. 1 illustrates a network implementation 100 of the present system and method to monitor the security of a plurality of occupants in a ridesharing environment, in accordance with an embodiment of the present invention. Although the present subject matter is explained considering that the present system 102 is implemented on a server, it may be understood that the present system 102 may also be implemented in a variety of computing systems, such as a laptop computer, a desktop computer, a notebook, a workstation, a mainframe computer, a server, a network server, and the like. It will be understood that the present system 102 may be accessed by multiple users through one or more computing devices 104-1, 104-2 . . . 104-N, collectively referred to as computing device 104 hereinafter, or applications residing on the computing device 104. Examples of the computing device 104 may include but are not limited to, a portable computer, a personal digital assistant, a handheld or mobile device, smart devices, and a workstation. The computing devices 104 are communicatively accessible to the present system 102 through a network 106.

In one implementation, the network 106 may be a wireless network, a wired network or a combination thereof. The network 106 can be implemented as one of the different types of networks, such as an intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

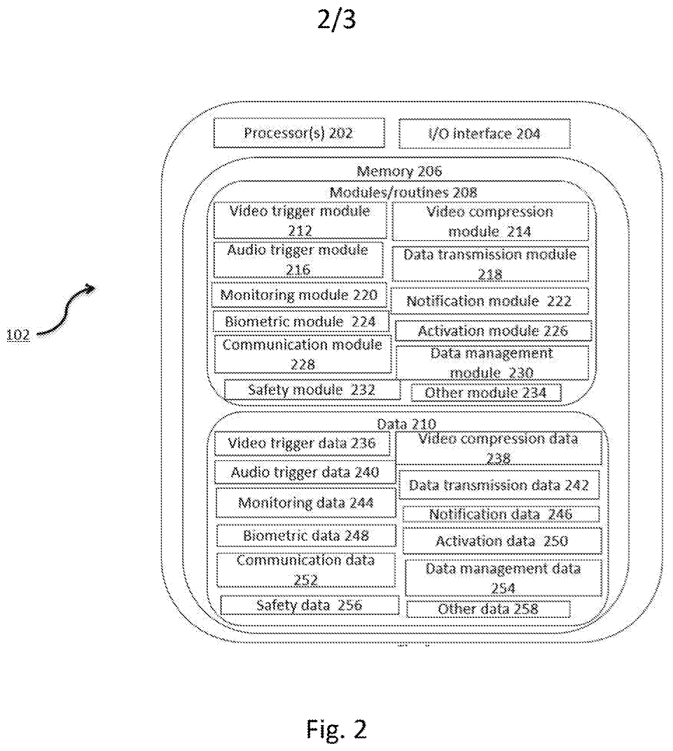

FIG. 2 illustrates the present system 102 to monitor the security of a plurality of occupants in a ridesharing environment, in accordance with an embodiment of the present invention. The system 102 may include at least one processor 202, an input/output (I/O) interface 204, and a memory 206.

The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the computing unit 104. Further, the 1/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a video trigger module 212, a video compression module 214, an audio trigger module 216, a data transmission module 218, a monitoring module 220, a notification module 222, a biometric module 224, an activation module 226, a communication module 228, a data management module 230, a safety module 232 and other module 234. The other modules 234 may include programs or coded instructions that supplement applications and functions of the system 102.

The data 210, amongst other things, serves as a repository for storing data processed, received, and generated by one or more of the modules 208. The data 210 may also include a video trigger data 236, a video compression data 238, an audio trigger data 240, a data transmission data 242, a monitoring data 244, a notification data 246, a biometric data 248, an activation data 250, a communication data 252, a data management data 254, a safety data 256 and other data 258. The other data 258 may include data generated as a result of the execution of one or more modules in the other module 234.

In one implementation, the video trigger module 212 captures one or more moving images of the occupants present in a vehicle and performing an analysis to recognize the face of the occupants. In an embodiment, the video trigger module 212 initiates a ride on recognizing the face of the occupants and facilitates the occupants to initiate a warning signal through a panic module integrated with the computing device 104 of the occupant. In an embodiment, the occupants include a passenger and a driver. In an exemplary embodiment, the video trigger module 212 may capture or record the moving images such as video in response to a triggering event such as a sudden deceleration or acceleration of the vehicle such as ridesharing car or bike.

The video compression module 214 reduces a frame rate of the captured moving images. Thus the video compression module 214 reduces the size of the captured data and minimizes the amount of data to be transferred. The audio trigger module 216 captures a plurality of audio signals generated by one or more objects present in the vehicle. In an embodiment, the audio trigger module 216 captures the audio signals generated by the objects present in the vehicle such as keywords, gunshots, and abnormally high sounds such as screams.

The data transmission module 218 transmits the captured moving images and the audio signals to a server unit. In an embodiment, the data transmission module 218 sends the captured data in textual form. The data transmission module 218 communicatively couples one or more computing devices of the occupants to the server unit. In an embodiment, the data transmission module 218 stores the captured moving images and the audio signals in a local storage of the computing device 104 of the occupants and transmits to the server unit on establishing a wireless network.

The monitoring module 220 detects one or more predefined suspicious activity by monitoring the captured video moving images in real-time and facilitates a remote user to initiate a telephonic call to an emergency service provider. The notification module 222 scans a number plate of the vehicle and transmits a plurality of data inputs to the emergency service provider. The plurality of data inputs comprising a location of the vehicle captured moving images and captured audio signals.

The notification module 222 establishes the telephonic call between the remote user and the emergency service provider. The biometric module 224 analyzes the captured moving images of the occupant and transmits the analyzed data to the server unit for authentication of the occupants. The activation module 226 activates the ride on recognizing the captured moving images of the occupants and establish a connection with an onboard diagnostics unit of the vehicle to control a plurality of parameters of the vehicle. In an embodiment, the plurality of parameters of the vehicle includes but not limited to a kill switch, steering, braking, parking, and to communicate with an autonomous vehicle.

The communication module 228 communicates a plurality of notifications to the server unit operated by the remote user. In an embodiment, the plurality of notifications includes a notification related to ridesharing at the server unit, a notification that moving images or video of the occupant is not captured and accept or request the driver to turn on, and notifications that computing device 104 is turned off or battery of the computing device 104 is depleted.

The data management module 230 creates partnerships with a plurality of telecommunication carriers such as mobile data service providers to allow internet data from the server unit such as present mobile application to not impact an internet data plan of the computing devices of the occupants. In an embodiment, the present system 102 may include a strobe light feature to turn on the strobe light flash to help the occupants to get away from an assault. The police are also notified of the location with the vehicle information and other details.

The safety module 232 facilitates the occupants to capture an image of the face to be part of the ridesharing environment. The safety module 232 executes facial recognition instructions to verify the occupants against pre-stored information in the database. The safety module 232 executes facial recognition instructions to verify the occupants against the pre-stored information in the database such as sex, violent acts of the occupants, etc. Further, the safety module 232 removes the occupant's account and flag if required.

In an embodiment, the present system and method may utilize as a software application or a mobile application which can be installed in the computing device 104 having an operating system such as Android, IOS, and Windows, etc.

The present system and method may be used in ridesharing or a messaging environment. For example, a mobile application based ridesharing services has brought a new transportation mode to the commuters, which can make reservations using mobile applications. In this case, the present system and method may facilitate a mobile application based ridesharing service to provide a safer ride experience for passengers and drivers. Additionally, the present system and method prevent the users from a crime such as sexual assault and armed robbery during usage of ridesharing services. Further, in the messaging environment, the present system and method may enable the user on the street to record or capture suspicious video and send to the police station so that a secure environment can be provided to the occupants present in the environment.

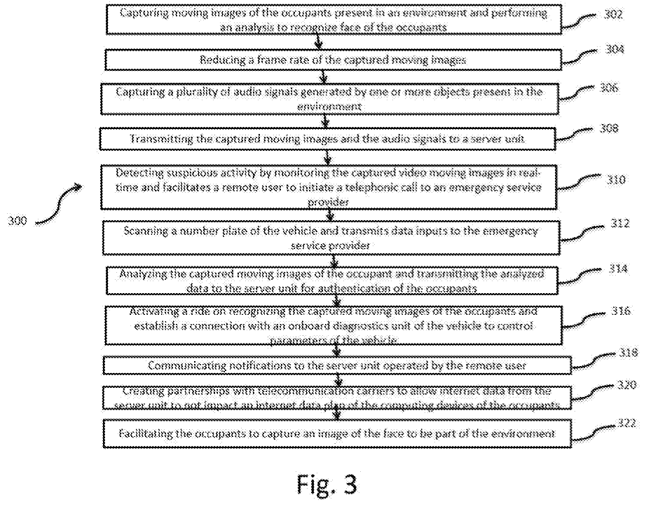

FIG. 3 illustrates a flowchart 300 of the method for monitoring security of a plurality of occupants in a ridesharing environment, in accordance with at least one embodiment. FIG. 3 is explained in conjunction with FIG. 1-2. The method includes a step 302 of capturing one or more moving images of the occupants present in a vehicle and performing an analysis to recognize face of the occupants through a video trigger module. In an embodiment, the video trigger module initiates a ride on recognizing the face of the occupants and facilitates the occupants to initiate a warning signal through a panic module integrated with the computing device of the occupant.

Then the method includes a step 304 of reducing a frame rate of the captured moving images through a video compression module. Further, the method includes the step 306 of capturing a plurality of audio signals generated by one or more objects present in the vehicle through an audio trigger module.

Furthermore, the method includes the step 308 of transmitting the captured moving images and the audio signals to a server unit through a data transmission module. The data transmission module communicatively couples one or more computing devices of the occupants to the server unit. The method then includes the step 310 of detecting one or more predefined suspicious activity by monitoring the captured video moving images in real-time and facilitates a remote user to initiate a telephonic call to an emergency service provider as a police station or hospital through a monitoring module. Then the method includes the step 312 of scanning a number plate of the vehicle and transmits a plurality of data inputs to the emergency service provider as a police station or hospital through a notification module.

The plurality of data inputs comprising a location of the vehicle captured moving images and captured audio signals. The notification module establishes the telephonic call between the remote user and the emergency service provider as a police station or hospital. The method then includes the step 314 of analyzing the captured moving images of the occupant and transmits the analyzed data to the server unit for authentication of the occupants through a biometric module.

The method then includes a step 316 of activating the ride on recognizing the captured moving images of the occupants and establish a connection with an onboard diagnostics unit of the vehicle to control a plurality of parameters of the vehicle through an activation module. Further, the method includes a step 318 of communicating a plurality of notifications to the server unit operated by the remote user through a communication module. The method includes a step 320 of creating partnerships with a plurality of telecommunication carriers to allow internet data from the server unit to not impact an internet data plan of the computing devices of the occupants through a data management module. The method then includes the step 322 of facilitating the occupants to capture an image of the face to be part of the ridesharing environment through a safety module. The safety module executes a plurality of facial recognition instructions to verify the occupants against pre-stored information in the database.

Thus the present system and method provide an efficient, simpler and more elegant framework to capture video and audio of the occupants and vehicle to create a safer ridesharing experience and monitors behavior of the occupants to prevent crime from occurring. Further, the present system and method provide a mobile application platform with a plurality of security and safety features such as video, audio, and biometrics to provide a safer ridesharing experience.

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

1. A method implemented by one or more processors for monitoring security of a plurality of occupants in a ridesharing environment, the method comprising:
capturing, by one or more processors, one or more moving images of the occupants present in a vehicle and performing an analysis to recognize face of the occupants through a video trigger module;
reducing, by one or more processors, a frame rate of the captured moving images through a video compression module;
capturing, by one or more processors, a plurality of audio signals generated by one or more objects present in the vehicle through an audio trigger module;
transmitting, by one or more processors, the captured moving images and the audio signals to a server unit through a data transmission module, wherein the data transmission module communicatively couples one or more computing devices of the occupants to the server unit;
detecting, by one or more processors, one or more predefined suspicious activity by monitoring the captured video moving images in real-time and facilitates a remote user to initiate a telephonic call to an emergency service provider through a monitoring module; and
analyzing, by one or more processors, the captured moving images of the occupant and transmits the analyzed data to the server unit for authentication of the occupants through a biometric module.

2. The method according to claim 1, comprises a step of scanning, by one or more processors, a number plate of a vehicle present in the environment to obtain a plurality of data inputs and transmitting the data inputs to the emergency service provider through a notification module, wherein the plurality of data inputs comprising a location of the vehicle, captured moving images, and captured audio signals, wherein the notification module establishes the telephonic call between the remote user and the emergency service provider.

3. The method according to claim 1, comprises a step of activating a ride on recognizing the captured moving images of the occupants and establish a connection with an onboard diagnostics unit of the vehicle to control a plurality of parameters of the vehicle through an activation module.

4. The method according to claim 1, comprises a step of communicating a plurality of notifications to the server unit operated by the remote user through a communication module.

5. The method according to claim 1, comprises a step of creating partnerships with a plurality of telecommunication carriers to allow internet data from the server unit to not impact an internet data plan of the computing devices of the occupants through a data management module.

6. The method according to claim 1, comprises a step of facilitating the occupants to capture an image of the face to be part of the ridesharing environment through a safety module, wherein the safety module executes a plurality of facial recognition instructions to verify the occupants against pre-stored information in the database.

7. The method according to claim 1, wherein the video trigger module initiates the ride on recognizing the face of the occupants, and facilitates the occupants to initiate a warning signal through a panic module integrated with the computing device of the occupant.

8. A system to monitor security of a plurality of occupants in a ridesharing environment, the system comprising:
a memory to store machine-readable instructions pertaining to monitoring security of the occupants; and
a processor coupled to the memory and operable to execute the machine-readable instructions stored in the memory, wherein the processor comprises:
a video trigger module to capture one or more moving images of the occupants present in a vehicle and performing an analysis to recognize face of the occupants;
a video compression module to reduce a frame rate of the captured moving images;
an audio trigger module to capture a plurality of audio signals generated by one or more objects present in the vehicle;
a data transmission module to transmit the captured moving images and the audio signals to a server unit, wherein the data transmission module communicatively couples one or more computing devices of the occupants to the server unit;
a monitoring module to detect one or more predefined suspicious activity by monitoring the captured video moving images in real-time and facilitates a remote user to initiate a telephonic call to an emergency service provider; and
a biometric module to analyze the captured moving images of the occupant and transmits the analyzed data to the server unit for authentication of the occupants.

9. The system according to claim 1, comprises a notification module to scan a number plate of a vehicle present in the environment to obtain a plurality of data inputs and transmitting the data inputs to the emergency service provider, wherein the plurality of data inputs comprising a location of the vehicle, captured moving images, and captured audio signals, wherein the notification module establishes the telephonic call between the remote user and the emergency service provider.

10. The system according to claim 1, comprises an activation module to activate a ride on recognizing the captured moving images of the occupants and establish a connection with an onboard diagnostics unit of the vehicle to control a plurality of parameters of the vehicle.

11. The system according to claim 1, comprises a communication module to communicate a plurality of notifications to the server unit operated by the remote user.

12. The system according to claim 1, comprises a data management module to create partnerships with a plurality of telecommunication carriers to allow internet data from the server unit to not impact an internet data plan of the computing devices of the occupants.

13. The system according to claim 1, comprises a safety module facilitates the occupants to capture an image of the face to be part of the ridesharing environment, wherein the safety module executes a facial recognition instructions to verify the occupants against pre-stored information in the database.

14. The system according to claim 1, wherein the video trigger module initiates the ride on recognizing the face of the occupants, and facilitates the occupants to initiate a warning signal through a panic module integrated with the computing device of the occupant.
